(19) United States
(12) Patent Application Publication
(10) Pub. No.: US 2026/0320794 A1
(43) Pub. Date: Oct. 15, 2026

(54) SCANNED IMAGE ACQUISITION METHOD FOR BIOLOGICAL SAMPLE

(71) Applicant: Ningbo Bio-eBeam Electron Beam Technology Co., Ltd., Ningbo (CN)

(72) Inventors: Tianping Gong, Ningbo (CN); Tao Ye, Ningbo (CN); Hailin Xing, Ningbo (CN); Wei Wang, Ningbo (CN); Xueqong Wei, Ningbo (CN)

(73) Assignee: Ningbo Bio-eBeam Electron Beam Technology Co., Ltd., Ningbo (CN)

(21) Appl. No.: 19/645,167

(22) Filed: Apr. 11, 2026

(30) Foreign Application Priority Data
Apr. 11, 2025 (CN) 202510450653.8

(51) Int. Cl. G06T 7/00

(52) U.S. Cl. CPC G06T 7/0012; G06T 2207/10061; G06T 2207/20024; G06T 2207/20081; G06T 2207/30004

(57) ABSTRACT

The present disclosure discloses a scanned image acquisition method for a biological sample. The method includes: first, acquiring a sectional sample of a to-be-scanned biological sample; then, controlling a scanning transmission electron microscope to perform trans-scanning on the sectional sample based on a plurality of sets of focusing parameters, and collecting, during the trans-scanning and using a composite detector, a current signal set at a focusing surface generated under each set of focusing parameters; next, performing image processing on the current signal set at each focusing surface to obtain a plurality of signal images at each focusing surface; and finally, performing image filtering on the plurality of signal images at each focusing surface using an image filtering algorithm to obtain a plurality of layer scanned images, where a total quantity of the layer scanned images is different from a total quantity of the signal images.

### CROSS-REFERENCE TO RELATED APPLICATIONS

This non-provisional application expressly claims the benefit of priority under the Paris Convention based on Chinese Application No. 202510450653.8, filed on Apr. 11, 2025, the entire disclosures of which is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present disclosure relates to a scanned image acquisition method for a biological sample, belonging to the technical field of electron microscopic imaging.

### BACKGROUND OF THE INVENTION

Acquisition of information about the internal structure of a biological sample is highly dependent on the quality of high-resolution images (that is, scanned images) generated by a scanning electron microscope (SEM for short), with axial resolution being particularly critical as a key factor to ensure the complete presentation of the information about the internal structure. The axial resolution of the scanned image is closely correlated to the section thickness of the biological sample. A smaller section thickness indicates a higher axial resolution, so that the features of the internal structure of the biological sample can be more precisely disclosed.

However, current methods for reducing the section thickness mainly focus on physical sectioning technologies, but such conventional technologies have significant limitations. Although the physical sectioning technologies work well in processing millimeter-scale samples, it is still difficult to meet requirements when achieving a nanometer-scale section thickness. Therefore, the existing physical sectioning technologies are insufficient in meeting requirements for high-precision and high-resolution imaging of the internal structure of a biological sample. It is urgent to provide a method capable of acquiring nanometer-scale axial high-resolution scanned images.

### SUMMARY OF THE INVENTION

A first technical problem to be resolved by the present disclosure is to provide a scanned image acquisition method for a biological sample.

Another technical problem to be resolved by the present disclosure is to provide a scanned image acquisition apparatus for a biological sample.

Still another technical problem to be solved by the present disclosure is to provide an electronic device configured to implement the foregoing scanned image acquisition method.

To achieve the foregoing technical objectives, the present disclosure adopts the following technical solutions:

According to a first aspect of embodiments of the present disclosure, a scanned image acquisition method for a biological sample is provided, which includes the following steps:
acquiring a sectional sample of a to-be-scanned biological sample;
controlling a scanning transmission electron microscope to perform trans-scanning on the sectional sample based on a plurality of sets of focusing parameters, and collecting, during the trans-scanning and using a composite detector, a current signal set of the sectional sample at a focusing surface generated under each set of focusing parameters;
performing image processing on the current signal set at each focusing surface to obtain a plurality of signal images at each focusing surface; and
performing image filtering on the plurality of signal images at each focusing surface using an image filtering algorithm to obtain a plurality of layer scanned images, where a total quantity of the layer scanned images is different from a total quantity of the signal images.

Preferably, the current signal set includes a plurality of types of current signals, and the plurality of types of current signals include at least two of the following: secondary electron, backscattered electrons, Auger electron, energy dispersive X-ray spectroscopy, bright field, and dark field.

Preferably, the composite detector includes a secondary electron detector, a backscattered electron detector, a bright field detector, and a dark field detector. The secondary electron detector is disposed right above the sectional sample. The backscattered electron detector is disposed on a side surface above the sectional sample. The bright field detector is disposed right below the sectional sample. The dark field detector is disposed on a side surface below the sectional sample.

Preferably, the image processing includes multistage multiplication amplification, signal transformation, sampling, digital signal processing, and AI image extraction.

Preferably, the plurality of sets of focusing parameters are acquired by the following sub-steps:
determining a scale factor of the sectional sample according to an original field of view size and a set limit size of the scanning transmission electron microscope, and adjusting a first gain and a second gain of the scanning transmission electron microscope according to the scale factor;
acquiring a quantity of required sets of focusing parameters, and determining a plurality of layers of the sectional sample according to the quantity of required sets; and
acquiring, for each layer, the focusing parameters of the layer using a parameter optimization algorithm to obtain the plurality of sets of focusing parameters, and restoring the first gain and the second gain to initial values.

Preferably, the performing trans-scanning on the sectional sample includes the following sub-steps:
focusing, by a converging lens of the scanning transmission electron microscope, a high-voltage focused incident electron beam into an electron beam probe, and performing point-by-point trans-scanning on the sectional sample based on the electron beam probe; and
deflecting, by a deflector of the scanning transmission electron microscope, the electron beam probe such that the electron beam probe performs line-by-line trans-scanning on the sectional sample.

The point-by-point trans-scanning and the line-by-line trans-scanning are performed in a continuous wide-angle raster scanning manner.

Preferably, the performing image filtering on the plurality of signal images at each focusing surface using an image filtering algorithm to obtain a plurality of layer scanned images specifically includes the following sub-steps:
performing adaptive filtering denoising and spatial registration on all the signal images of each focusing surface to obtain aligned images corresponding to all the signal images;
calculating a quality score of each aligned image based on a definition, a noise level, and a structural similarity of the aligned image, and selecting effective images according to the quality scores of the aligned images;
initializing a point spread function according to a preset kernel function by taking the effective images as an input, and reconstructing images through a noise confidence-guided iterative deconvolution algorithm;
selecting a plurality of to-be-processed layer scanned images according to gradient features and noise confidences of the reconstructed images; and
performing luminance equalization and contrast enhancement on the plurality of to-be-processed layer scanned images to obtain the plurality of layer scanned images.

Preferably, the noise confidence is obtained by the following method:
performing wavelet decomposition on the image to obtain high-frequency subbands to calculate global noise variance; calculating local variance through a sliding window; and obtaining the noise confidence of each pixel by exponential function mapping based on a difference between the local variance and the global variance.

Preferably, during the image reconstruction, point spread function parameters are adjusted according to a structural similarity gradient, and an update intensity is controlled through a noise weight matrix.

Preferably, a section thickness of the sectional sample is 30 to 100 nm.

Preferably, the quantity of the plurality of sets of focusing parameters is determined according to an axial resolution requirement of the scanned images, and the axial resolution requirement is a nanometer-scale resolution.

Preferably, a sample processing device includes a sectioning apparatus, a plasma processing apparatus, and a film coating apparatus. The sectional sample is acquired from the sample processing device by the following sub-steps:
consecutively cutting the to-be-scanned biological sample using the sectioning apparatus to obtain a plurality of to-be-processed sample sections;
performing plasma thinning significance processing and surface conducting film plating on the plurality of sample sections using the plasma processing apparatus and the film coating apparatus to obtain a plurality of sample sections; and
determining the sectional sample from the plurality of sample sections.

According to a second aspect of the embodiments of the present disclosure, a scanned image acquisition apparatus for a biological sample is provided, which includes:
an acquisition module, configured to acquire a sectional sample of a to-be-scanned biological sample;
a collection module, configured to control a scanning transmission electron microscope to perform trans-scanning on the sectional sample based on a plurality of sets of focusing parameters, and collect, during the trans-scanning and using a composite detector, a current signal set of the sectional sample at a focusing surface generated under each set of focusing parameters;
an image processing module, configured to perform image processing on the current signal set at each focusing surface to obtain a plurality of signal images at each focusing surface; and
an image filtering module, configured to perform image filtering on the plurality of signal images at each focusing surface using an image filtering algorithm to obtain a plurality of layer scanned images, where a total quantity of the layer scanned images is different from a total quantity of the signal images.

According to a third aspect of the embodiments of the present disclosure, an electronic device is provided, which includes:
at least one processor; and
a memory communicatively connected to the at least one processor.

The memory stores instructions executable by the processor, and the instructions are executed by the processor to cause the processor to implement the foregoing scanned image acquisition method.

Compared with the prior art, in the present disclosure, the sectional sample of the biological sample is trans-scanned based on the plurality of sets of focusing parameters by using the scanning transmission electron microscope, and the plurality of types of current signals at each focusing surface are collected by using the composite detector, so as to realize “secondary sectioning” of the physical section. That is, the sectional sample is further divided into the plurality of focusing surfaces, so that a distance between scanned image layers corresponding to adjacent focusing surfaces reaches the nanometer scale, thereby significantly improving the axial resolution of the scanned images. In addition, multistage multiplication amplification, signal transformation, sampling, digital signal processing, and AI image extraction are performed on multimodal current signals, and adaptive filtering denoising, spatial registration, quality score-based selection, noise confidence-guided iterative deconvolution reconstruction, as well as luminance equalization and contrast enhancement are performed on the signal images in combination with the image filtering algorithm to finally obtain the high-quality layer scanned images, thereby ensuring image definition and structural integrity while improving the axial resolution, and resolving the technical problem that it is difficult for conventional physical sectioning technologies to implement nanometer-scale high-resolution imaging.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form, omitted, or merely suggested, in order to avoid unnecessarily obscuring the present invention.

FIG. 1 is a schematic flowchart of a scanned image acquisition method for a biological sample according to a first embodiment of the present disclosure;

FIG. 2 is an exemplary diagram of an arrangement manner of a composite detector according to the first embodiment of the present disclosure;

FIG. 3 is a schematic structural diagram of a scanned image acquisition apparatus for a biological sample according to a second embodiment of the present disclosure; and

FIG. 4 is a schematic structural diagram of an electronic device according to a third embodiment of the present disclosure.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

It is also to be understood that the terminology used herein is for the purpose of describing particular embodiments only, and is not intended to limit the scope of the invention. For example, when an element is referred to as being “on”, “connected to”, or “coupled to” another element, it can be directly on, connected or coupled to the other element or intervening elements may be present. In contrast, when an element is referred to as being “directly on”, “directly connected to”, or “directly coupled to” another element, there are no intervening elements present.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

To make the objectives, features, and advantages of the present disclosure clearer and more comprehensible, the following clearly and completely describes the technical solutions in the embodiments of the present disclosure with reference to the accompanying drawings in the embodiments of the present disclosure. Apparently, the embodiments described are merely some rather than all of the embodiments of the present disclosure. All other embodiments obtained by those skilled in the art based on the embodiments of the present disclosure without creative efforts shall fall within the protection scope of the present disclosure.

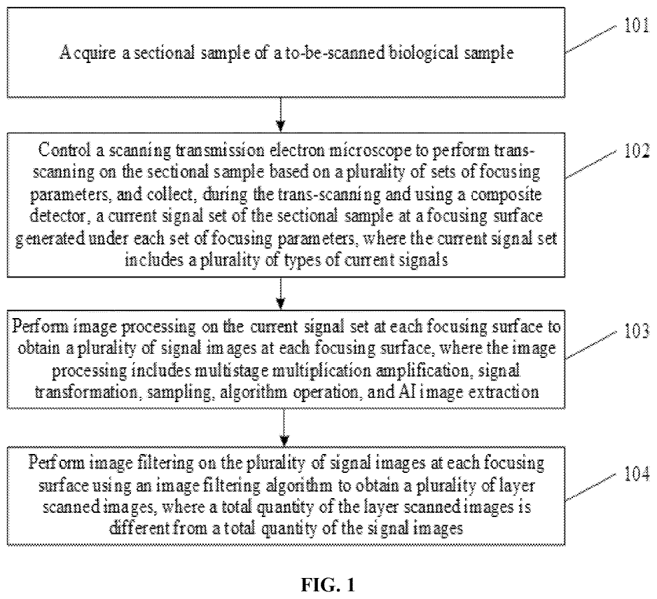

Referring to FIG. 1, a first embodiment of the present disclosure provides a scanned image acquisition method for a biological sample, which includes at least the following steps:

Step 101: Acquire a sectional sample of a to-be-scanned biological sample.

To acquire thinner scanned images of the biological sample, the to-be-scanned biological sample needs to be sectioned, so as to obtain a sectional sample of the to-be-scanned biological sample for subsequent generation of scanned images.

In one embodiment of the present disclosure, the sectional sample of the to-be-scanned biological sample may be acquired through the following two manners: an acquisition signal is sent to a biological sample sectioning device to make the sectioning device transfer the sectional sample of the biological sample to a corresponding processing position; or in a case that a scanned image acquisition instruction sent by a user is received, the sectional sample placed at a corresponding processing position by the user is received.

In another embodiment of the present disclosure, the sectional sample of the to-be-scanned biological sample is acquired from a sample processing device. The sample processing device includes a sectioning apparatus, a plasma processing apparatus, and a film coating apparatus. The sectional sample is obtained by the following operations: the to-be-scanned biological sample is consecutively cut using the sectioning apparatus to obtain a plurality of to-be-processed sample sections; plasma thinning significance processing and surface conducting film coating are performed on the plurality of sample sections using the plasma processing apparatus and the film coating apparatus to obtain a plurality of sample sections; and the sectional sample is determined from the plurality of sample sections.

In one embodiment of the present disclosure, a section thickness of the sectional sample is 30 to 100 nm. The section thickness is the minimum cross-sectional thickness, which is limited by the diamond cutter, the sectioning apparatus, and the process. Preferably, the minimum cross-sectional thickness is 30 to 100 nm.

Step 102: Control a scanning transmission electron microscope to perform trans-scanning on the sectional sample based on a plurality of sets of focusing parameters, and collect, during the trans-scanning and using a composite detector, a current signal set of the sectional sample at a focusing surface generated under each set of focusing parameters, where the current signal set includes a plurality of types of current signals.

The scanned images are acquired mainly by using an electron microscope. A scanning electron microscope (SEM) typically uses a secondary electron detector (SED) and a backscattered electron detector (BSED). However, the SEM can only acquire information such as the surface morphology and the composition of a sample, and cannot detect the internal structure of the sample. A transmission electron microscope (TEM) typically uses a bright field detector (BFS) and a dark field detector (DFD), has a resolution higher than that of the SEM, and can observe internal information of the sample to obtain the element composition and the space structure of the sample. Therefore, to acquire richer information about the internal structure of the biological sample, in the embodiment of the present disclosure, a scanning transmission electron microscope (STEM) having features of both an SEM and a TEM is used for trans-scanning the sample section, so as to obtain a plurality of types of internal information of the sample, thereby obtaining a three-dimensional structure of the sample section. The trans-scanning is a combination of scanning and transmission.

A section thickness of a sectional sample obtained by using a physical sectioning technology may fail to achieve a nanometer scale. Therefore, in the embodiment of the present disclosure, the sectional sample is subject to secondary cutting by using the scanning transmission electron microscope, so as to further cut the sectional sample into a sample meeting the nanometer scale requirement. Specifically, by setting a plurality of sets of focusing parameters and adjusting the scanning transmission electron microscope based on these focusing parameters, the scanning transmission electron microscope can be controlled to divide the sectional sample into a plurality of focusing surfaces at different depths, thereby effectively reducing an equivalent section thickness of the sample section. Each set of focusing parameters corresponds to one depth layer of the sample section.

To acquire various types of current signals generated at each focusing surface during the trans-scanning, the composite detector is arranged around the sample section. The composite detector is composed of a plurality of detectors, and each detector is configured to acquire a specific type of current signals. During the trans-scanning, the current signal set of the sectional sample at each focusing surface is continuously collected through the composite detector. The current signal set includes a plurality of types of current signals.

In one embodiment of the present disclosure, the quantity of the plurality of sets of focusing parameters is determined according to an axial resolution requirement of the scanned images. The axial resolution requirement is a nanometer-scale resolution. The axial resolution is defined as the minimum distance between scanned images corresponding to two adjacent focusing surfaces. If the axial resolution is distributed at equal intervals, the value is equal to an original section thickness of the sectional sample divided by the quantity of focusing surface layers. A larger quantity of focusing surfaces indicates a larger quantity of layers of the sectional sample and a higher axial resolution. Therefore, by controlling the quantity of focusing surfaces, the axial resolution can be controlled, so as to obtain scanned images with an axial resolution on the order of several nanometers. The plurality of sets of focusing parameters are arranged in a size order, and the distance between two adjacent sets of focusing parameters is equal.

For example, based on physical sectioning, “secondary sectioning” is performed on the sectional sample through the plurality of sets of focusing parameters of the scanning transmission electron microscope. That is, a physical sectional sample having a thickness of 30 to 100 nm is further divided into a plurality of focusing surfaces, each focusing surface corresponds to one set of focusing parameters, and the distance between scanned images corresponding to adjacent focusing surfaces is the final axial resolution. For example, when the thickness of the sectional sample is 30 nm, four sets of equidistant focusing parameters are set, so that the axial resolution can be improved to 30 nm/4=7.5 nm, thereby achieving the nanometer scale.

In one embodiment of the present disclosure, a plurality of sets of focusing parameters need to be acquired. First, a scale factor of the sectional sample is determined according to an original field of view size and a set limit size of the scanning transmission electron microscope, and a first gain and a second gain of the scanning transmission electron microscope are adjusted according to the scale factor. Second, a quantity of sets of focusing parameters is acquired, and a plurality of layers of the sectional sample are determined according to the quantity of sets. Finally, for each layer, the focusing parameters of the layer are acquired using a parameter optimization algorithm to obtain the plurality of sets of focusing parameters. Each set of focusing parameters includes a coarse adjustment parameter and a fine adjustment parameter.

Specifically, acquiring the quantity of sectioning layers of the sectional sample is equal to determining the quantity of sets of focusing parameters, because each layer corresponds to one set of focusing parameters. After the layers are determined, specific focusing parameters of each layer need to be further determined. In the embodiment of the present disclosure, the parameter optimization algorithm is preferably used for determining the focusing parameters.

Before the parameter optimization algorithm is used, a field of view of the scanning transmission electron microscope further needs to be preprocessed, that is, image scaling is performed on an image displayed by the scanning transmission electron microscope. The image scaling process is the gain adjustment process.

In one embodiment of the present disclosure, the specific process of preprocessing the field of view includes:
When the original field of view size (W×H) meets max(W,H)>1024 (set limit size), the first gain Gₓ and the second gain G_{y} execute scaling:

$$s = ( max ( W , H ) ) / 1024 ) , \{ \begin{matrix}{G}_{x}^{′} = ⌊ \frac{{G}_{x}}{s} ⌋ \\ {G}_{y}^{′} = ⌊ \frac{{G}_{y}}{s} ⌋\end{matrix}$$

where s is the scaling ratio, that is, the scale factor.

After the field of view is preprocessed, the focusing parameters of each layer are determined, and the process of acquiring the focusing parameters of each layer based on the parameter optimization algorithm may include:
1) coarse granularity search (c stands for coarse, namely the coarse adjustment parameter, and f stands for fine, namely the fine adjustment parameter), where the coarse adjustment parameter represents a coarse adjustment value of an objective lens, and the fine adjustment parameter represents a fine adjustment value of an objective lens:
initialization: (c₀,f₀)∈[0,1000]×[0,200];
traversing: fₖ=10 m(m=0, 1, . . . , 20;
updating:

$$( {c}^{*} , {f}^{*} ) = arg {max}_{c , f} S ( I ( c , f ) ) ,$$

where S(I(c,f)) is a current sharpening indicator;
boundary detection: if f*≤20 then c←c−1f*≥180 then c←c+1;
steps of traversing, updating, and boundary detection are repeated until f*∈(20,180).
2) medium granularity search;
step size: Δf=3;
search domain: f∈{f*−6, f*−3, f*, f*+3, f*+6}∩[0,200];
updating: f**=argmax S((c*,f));
3) fine granularity search;
step size: Δf=1;
search domain: f∈(f*−2, f*−1, f*, f*+1, f*+2)∩|[0,200];
updating: f***=argmax S((c*,f)
4) sub-pixel interpolation optimization (secondary curve difference σ is initialized to 0);
if f*** is not at the boundary of the search domain, the secondary curve difference σ is calculated:

$$σ = \frac{S ( I ( c , {f}^{** *} + Δ f ) ) - S ( I ( c , {f}^{** *} - Δ f ) )}{- 2 [ S ( I ( c , {f}^{** *} + Δ f ) ) + S ( I ( c , {f}^{** *} - Δ f ) ) - 2 S ( I ( c , {f}^{** *} ) ) ]}$$

$${f}_{final} = {f}^{** *} + σ * Δ f$$

5) output of focusing parameters of each layer

$$( {c}_{final} , {f}_{final} ) = \{ \begin{matrix}( {c}^{*} , {f}_{final} ) , & σ \neq 0 \\ ( {c}^{*} , {f}^{** *} ) , & σ = 0\end{matrix}$$

is determined as the final focusing parameters, and the first gain Gₓ and the second gain G_{y} are restored to initial values.

It should be noted that the plurality of sets of focusing parameters in the embodiment of the present disclosure are a collection of sets of focusing parameters respectively calculated for the plurality of layers of the sectional sample. Each set of focusing parameters corresponds to one layer, and is independently calculated by the parameter optimization algorithm to finally form a set of focusing parameters. Therefore, the plurality of sets of focusing parameters is an overall concept, and the final focusing parameters refer to specific values of each set.

Step 103: Perform image processing on the current signal set at each focusing surface to obtain a plurality of signal images at each focusing surface.

Specifically, the image processing includes multistage multiplication amplification, signal transformation, sampling, digital signal processing, and AI image extraction. It may be understood that the foregoing image processing steps may selectively use some of the processing manners according to actual signal strength, noise level, and imaging quality requirements. For example, in a case that the signal strength is sufficient, the amplification process may be properly simplified. In a case that the signal type is relatively simple, the signal transformation process may be simplified. Those skilled in the art may flexibly combine the foregoing processing manners according to actual requirements, so as to achieve a balance between imaging efficiency and image quality.

In one embodiment of the present disclosure, the multistage multiplication amplification, the signal transformation, the sampling, the digital signal processing, and the AI image extraction are sequentially performed on the current signal set of each focusing surface, so as to obtain a plurality of signal images at each focusing surface.

Current signals generated in the scanning transmission electron microscope are very weak. Therefore, the multistage multiplication amplification needs to be first performed, so as to ensure that the signal strength meets the subsequent processing requirements. The amplified current signals are then subject to signal transformation. The signal transformation includes, but is not limited to, processing such as filtering and modulation, aiming to remove noises, improve the signal-to-noise ratio, or change a signal form. For ease of subsequent processing, continuous trans-scanning current signals further need to be converted into discrete signals by sampling, that is, analog signals are converted into digital signals.

The digital signal processing needs to be performed on the sampled digital signals to extract useful information. The digital signal processing includes statistical analysis, frequency domain analysis, image reconstruction, and the like of a signal, aiming to extract information reflecting characteristics of the sample from the original digital signal.

The final step is the AI image extraction, that is, the signals obtained after the digital signal processing are converted into visualized images. The image extraction includes processing such as image enhancement, filtering, and segmentation, and may be performed by using a conventional AI image extraction manner or an image conversion algorithm. Details are not described herein again.

Step 104: Perform image filtering on the plurality of signal images at each focusing surface using an image filtering algorithm to obtain a plurality of layer scanned images, where a total quantity of the layer scanned images is different from a total quantity of the signal images.

Due to reasons such as loss of current signals, the signal images obtained after image processing may be defective. Therefore, all signal images need to be filtered based on the image filtering algorithm to remove the defective images, thereby finally obtaining a plurality of high-quality layer scanned images. In one embodiment of the present disclosure, because the plurality of layer scanned images are obtained by means of filtering based on all the signal images, the quantity of the layer scanned images is less than the quantity of the signal images.

In one embodiment of the present disclosure, the process of performing image filtering on the plurality of signal images at each focusing surface using the image filtering algorithm to obtain the plurality of layer scanned images of the sectional sample specifically includes: perform adaptive filtering denoising and spatial registration on all the signal images of each focusing surface to obtain aligned images corresponding to all the signal images; calculate a quality score of each aligned image based on a definition, a noise level, and a structural similarity of the aligned image, and select effective images according to the quality scores of the aligned images; initialize a point spread function according to a preset kernel function by taking the effective images as an input, and reconstruct images through a noise confidence-guided iterative deconvolution algorithm; select a plurality of to-be-processed layer scanned images according to gradient features and noise confidences of the reconstructed images; and perform luminance equalization and contrast enhancement on the plurality of to-be-processed layer scanned images to obtain the plurality of layer scanned images. The noise confidence is obtained based on local variance and global variance. During the image reconstruction, point spread function parameters are adjusted according to a structural similarity gradient, and an update intensity is controlled through a noise weight matrix.

Herein, for example, there are n focusing surfaces, each focusing surface includes k signal images, and m (m≤k×n) layer scanned images are obtained through image filtering. Then, the process of performing image filtering on the k×n signal images includes:

### 1) Adaptive Filtering Denoising

Adaptive non-local mean denoising (adaptive NLM) is used for image denoising to suppress noise while keeping detailed features of the biological sample as much as possible. The specific design of the adaptive non-local mean denoising is as follows:

For an image I, a filtering value of a pixel x is

$$\hat{I} ( x ) = \frac{1}{C ( x )} {\sum }_{y ∈ {γ}_{x}} ω ( x , y ) \cdot I ( y )$$

where the weight function is ω(x,y):

$$ω ( x , y ) = exp ( - \frac{{‖ {φ}_{x} - {φ}_{y} ‖}_{G}^{2}}{{h}_{x}^{2}} )$$

φₓ and φ_{y} are adaptive blocks (with a side length δₓ=[3σₓ], where σₓ is a local standard deviation of field x) centered at pixel coordinates (x,y), and γₓ is a collection of y of all pixels whose horizontal coordinate includes x.

Distance measurement ∥·∥_{G} uses Gaussian weighted Euclidean distance:

$${‖ {φ}_{x} - {φ}_{y} ‖}_{G}^{2} = {\sum }_{k} {G}_{{σ}_{g}} ( k ) \cdot {( {φ}_{x} ( k ) - {φ}_{y} ( k ) )}^{2}$$

where the standard deviation of the Gaussian function is: σ_{g}=0.5δₓ, k is the index variable, and G_{σ}_{_{g}} is the Gaussian kernel function, which is positively correlated with k and σ_{g}.

The adaptive smoothing parameter is hₓ:
hₓ=α·ₓ·\sqrt{δₓ}, where α is the user-defined weight, which is usually 0.8. C(x) is the normalization factor:

$$C ( x ) = {\sum }_{y ∈ {γ}_{x}} ω ( x , y )$$

### 2) Registration

The images are registered based on an anisotropic guided registration algorithm to obtain the aligned images. The anisotropic guided registration algorithm is specifically designed as follows:

Assuming that the reference image is I_{ref} and the to-be-registered image is Iₘₒᵥ, a transformation matrix T* is solved by minimizing an anisotropic loss function:

$${T}^{*} = arg {min}_{T} {\sum }_{p} w ( p ) \cdot {‖ {∇}_{θ} {I}_{ref} ( p ) - {∇}_{θ} ( {I}_{mov} \cdot T ) ( p ) ‖}^{2}$$

the gradient orientation constraint is ∇_{θ}:

∇_{θ}I(p)=cos θ·Iₓ(p)+sin θ·I_{y}(p)

where θ is determined by the main gradient orientation of the reference image at point p:

$$θ ( p ) = arctan ( \frac{{G}_{y} ( p )}{{G}_{x} ( p )} ) , {G}_{x} = I * {K}_{x} , {G}_{y} = I * {K}_{y}$$

where Kₓ, K_{y} represent convolution kernels of horizontal and vertical coordinates;
the anisotropic weight is w(p):

$$w ( p ) = exp ( - \frac{‖ ∇ {I}_{ref} ( p ) ‖}{2 {σ}_{w}^{2}} )$$

a higher weight is given to an edge region.

The transformation model is T: parameterization of affine transformation:

$$T ( p ) = [ \begin{matrix}{a}_{11} & {a}_{12} \\ {a}_{21} & {a}_{22}\end{matrix} ] [ \begin{matrix}x \\ y\end{matrix} ] + [ \begin{matrix}{t}_{x} \\ {t}_{y}\end{matrix} ]$$

where a₁₁, a₁₂, a₂₁, a₂₂, tₓ, and t_{y} are internal parameters of an affine matrix, and x, y are horizontal and vertical coordinates of a pixel.

### 3) Image Quality Score Calculation

Whether the images are defective is determined by an image quality evaluation function designed for calculating a quality score.

In one embodiment of the present disclosure, the image quality evaluation function is specifically as follows:

$$Q = {w}_{1} \cdot \frac{T}{{T}_{max}} + {w}_{2} \cdot \frac{1}{{σ}^{2}} + {w}_{3} \cdot SSIM$$

where the Tenengrad gradient (corresponding to definition T) is represented by the following formula:

$$T = {\sum }_{x , y} ( {G}_{x}^{2} + {G}_{y}^{2} ) ,$$

Gₓ=I*Sₓ, G_{y}=I*S_{y}, where S is the Sobel operator;
the noise level is the median σ² of the local variance;
SSIM represents structural similarity; and
the weight is w₁+w₂+w₃=1.

For the k signal images of each focusing layer nᵢ, the images with first p (p≤k) largest Q values are reserved or the images with Q values less than a threshold Qₜₕᵣₑₛₕ are eliminated to obtain effective images, where p and the threshold Qₜₕᵣₑₛₕ are set according to actual requirements.

### 5) Image Reconstruction

A noise adaptive Richardson-Lucy deconvolution algorithm is used for performing a fuzzy analytic hierarchy process, and k*p fuzzy images are reconstructed. m layers of images are selected through k times of iterative optimization layering. The point spread function (PSF) estimation of each layer is H_{z}, where z∈{1, 2, . . . , p} represents the depth of focus. That is, for each layer, the specific procedure is as follows:

a. Initialization

A fuzzy image O_{z} is inputted, and a PSF estimation

$${H}_{z}^{( 0 )}$$

(preset kernel function) is initialized. Global noise variance

$${σ}_{global}^{2}$$

is calculated. The noise variance is calculated by the following method: perform three-layer wavelet decomposition on the image to obtain high-frequency subbands {D₁,D₂,D₃}. The variance is as follows:

α²=median(|D₁|)/0.6745

The noise confidence is:

$$c ( x , y ) = exp ( - \frac{\vert {σ}_{local}^{2} ( x , y ) - {σ}_{global}^{2} \vert}{τ} ) ,$$

where τ is the attenuation coefficient, which is 10 by default, and

$${σ}_{local}^{2} ( x , y )$$

is the local variance of a 5×5 sliding window.
b. Iterative Optimization

Dynamic PSF correction is performed (for example, H is updated once every 5 times, but this application is not limited thereto).

$${H}_{z}^{( k + 1 )} = {H}_{z}^{( k )} + η \cdot \frac{\partial L}{\partial {H}_{z}} ,$$

where η is the learning rate. The loss function L is:

$$L = {\sum }_{x , y} {‖ {O}_{z} ( x , y ) - {H}_{z}^{( k )} * {I}_{z}^{( k )} ( x , y ) ‖}^{2} + μ \cdot TV ( {H}_{z} )$$

where TV(H_{z}) is the total variation regularization of the PSF, and μ is the balance coefficient, which is 0.01 by default.

Noise weight update: the weight W(x,y) is calculated according to the local variance to dynamically adjust the pixel-level iteration step size:

$$W ( x , y ) = \frac{1}{1 + λ \cdot {σ}_{local}^{2} ( x , y )}$$

where λ is the empirical parameter, which is 0.1 by default. Larger noise indicates a smaller iteration step quantity, and noise amplification is suppressed.

Regularization term RL iteration:

$${I}_{k + 1} = {I}_{k} \cdot [ W \cdot ( {H}_{z}^{T} * \frac{{O}_{z}}{{H}_{z} * {I}_{k}} ) ] - β \cdot ∇ SSIM ( {I}_{k} , {O}_{z} ) , {I}_{k} \geq 0$$

where the gradient item is ∇SSIM: based on the gradient descending orientation of the structural similarity index, the coefficient β is adaptively adjusted with the noise level:

$$β = γ \cdot \frac{{σ}_{global}^{2}}{max ( {σ}_{local}^{2} ( x , y ) , ϵ )} ,$$

where ∈ is a small constant for preventing division by 0.
c. Layer Screening

The gradient T_{z} and the noise confidence c_{z} of each layer are calculated, and the layers (m≤k×n) with T_{z}>Tₜₕᵣₑₛₕ and c_{z}>cₜₕᵣₑₛₕ are reserved. Tₜₕᵣₑₛₕ and cₜₕᵣₑₛₕ are gradient and noise confidence thresholds, which may be set according to actual requirements.

Therefore, in the embodiment of the present disclosure, the sample section is finely divided into a plurality of focusing surfaces by using the plurality of sets of focusing parameters, so as to realize “secondary sectioning” of the sample section, and the axial resolution of the scanned images is greatly improved to a nanometer scale.

In one embodiment of the present disclosure, the process of controlling the scanning transmission electron microscope to perform trans-scan on the sectional sample based on the plurality of sets of focusing parameters specifically includes: sequentially adjust the focusing parameters of the scanning transmission electron microscope based on the plurality of sets of focusing parameters, and control the scanning transmission electron microscope to generate a high-voltage focused incident electron beam corresponding to each set of focusing parameters, so as to perform point-by-point and line-by-line trans-scanning on the focusing surface of the sectional sample generated under each set of focusing parameters. By adjusting the focusing parameters of the high-voltage focused incident electron beam, n layers of focusing surfaces of the sample section can be obtained. The n layers of focusing surfaces are subject to trans-scanning, and then signals are collected for each layer of focusing surface based on the composite detector. n is a positive integer.

In one embodiment of the present disclosure, the point-by-point and line-by-line trans-scanning specifically includes: focus, by a converging lens of the scanning transmission electron microscope, the high-voltage focused incident electron beam into an electron beam probe, and perform point-by-point trans-scanning on the sectional sample based on the electron beam probe; and deflect, by a deflector of the scanning transmission electron microscope, the electron beam probe such that the electron beam probe performs line-by-line trans-scanning on the sectional sample. The point-by-point trans-scanning and the line-by-line trans-scanning are performed in a continuous wide-angle raster scanning manner.

During the trans-scanning, the process of point-by-point trans-scanning includes: focus an incident electron beam into an electron beam “probe” based on the converging lens, and perform point-by-point trans-scanning on the sample. The process of line-by-line trans-scanning includes: deflect, by the deflector, the electron beam such that the electron beam performs line-by-line trans-scanning on the sample. The point-by-point and line-by-line trans-scanning is also performed in a continuous wide-angle raster scanning manner.

It should be noted that the raster scanning manner is a general term in the art for performing two-dimensional scanning on a surface of a sample by an electron beam, and “continuous wide-angle” further defines the continuity of deflection of the electron beam and a deflection angle range.

In one embodiment of the present disclosure, the plurality of types of current signals include at least two of the following: secondary electron (SE), backscattered electrons (BSE), Auger electron (AE), energy dispersive X-ray spectroscopy (EDX), bright field (BF), and dark field (DF).

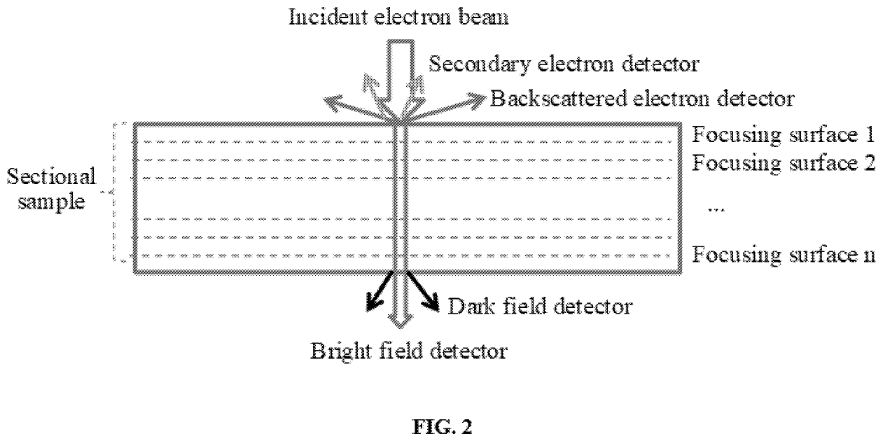

Referring to FIG. 2, in one embodiment of the present disclosure, the composite detector includes a secondary electron detector, a backscattered electron detector, a bright field detector, and a dark field detector. The secondary electron detector is disposed right above the sectional sample. The backscattered electron detector is disposed on a side surface above the sectional sample. The bright field detector is disposed right below the sectional sample. The dark field detector is disposed on a side surface below the sectional sample. It should be noted that the arrangement manner shown in FIG. 2 is only a specific example, and the foregoing orientation descriptions are exemplary descriptions based on the present embodiment and do not constitute a limitation to the arrangement directions of the detectors. Those skilled in the art may adjust relative positions of the detectors according to actual detection requirements.

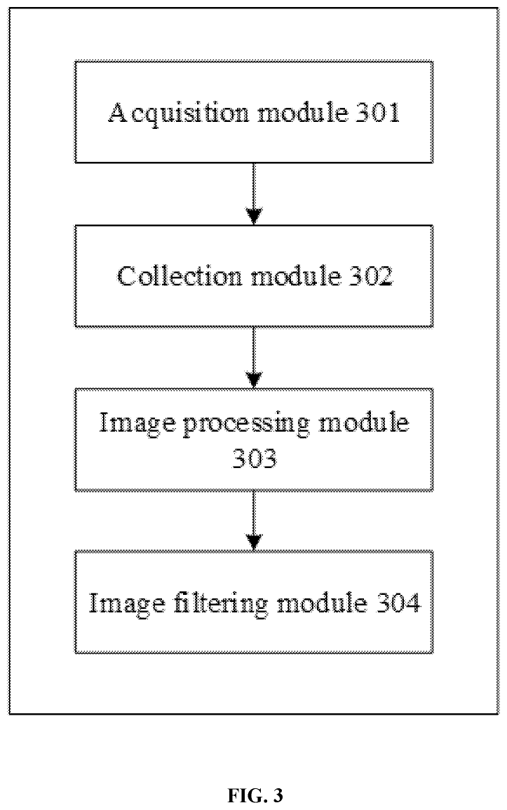

Referring to FIG. 3, based on the foregoing scanned image acquisition method for a biological sample, a second embodiment of the present disclosure further provides a scanned image acquisition apparatus for a biological sample. The scanned image acquisition apparatus at least includes an acquisition module 301, a collection module 302, an image processing module 303, and an image filtering module 304.

The acquisition module 301 is configured to acquire a sectional sample of a to-be-scanned biological sample.

The collection module 302 is configured to control a scanning transmission electron microscope to perform trans-scanning on the sectional sample based on a plurality of sets of focusing parameters, and collect, during the trans-scanning and using a composite detector, a current signal set of the sectional sample at a focusing surface generated under each set of focusing parameters.

The image processing module 303 is configured to perform image processing on the current signal set at each focusing surface to obtain a plurality of signal images at each focusing surface. In one embodiment of the present disclosure, the image processing includes multistage multiplication amplification, signal transformation, sampling, digital signal processing, and AI image extraction. It may be understood that in other embodiments, it is allowed to select only some of the foregoing image processing manners, as long as the objective of image generation can be achieved.

The image filtering module 304 is configured to perform image filtering on the plurality of signal images at each focusing surface using an image filtering algorithm to obtain a plurality of layer scanned images, where a total quantity of the layer scanned images is different from a total quantity of the signal images.

It should be noted that the scanned image acquisition apparatus provided in the embodiment of the present disclosure is similar to the description in the foregoing method embodiment and has beneficial effects similar to those in the method embodiment, and therefore, details are not described again. Technical details not enumerated in the scanned image acquisition apparatus may be supplemented according to corresponding descriptions in FIG. 1 and FIG. 2.

A third embodiment of the present disclosure provides an electronic device, which includes: at least one processor; and a memory communicatively connected to the at least one processor. The memory stores instructions executable by the processor, and the instructions are executed by the processor to cause the processor to be capable of implementing the foregoing scanned image acquisition method.

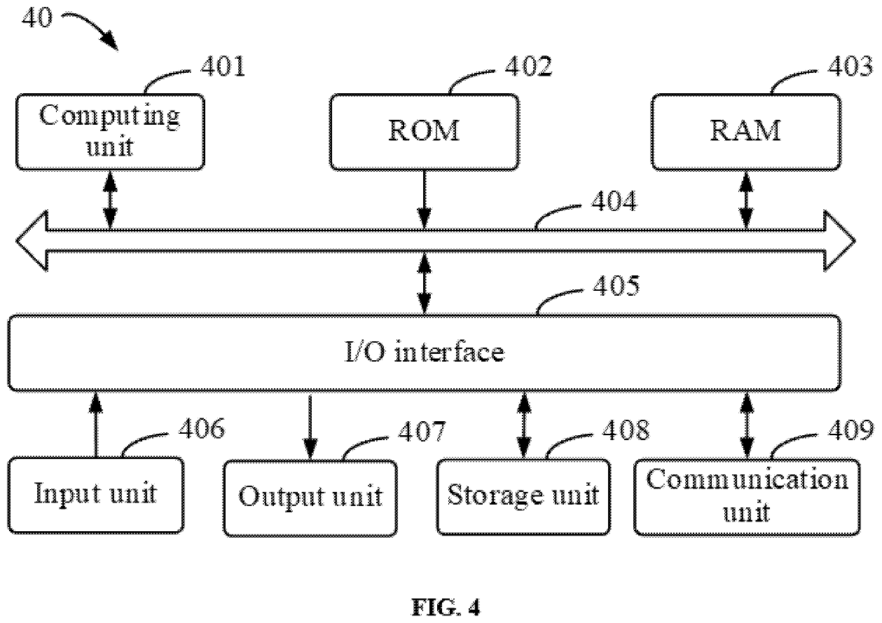

FIG. 4 is a schematic block diagram of an electronic device 40 according to the third embodiment of the present disclosure. The electronic device may include various forms of digital computers, such as a laptop computer, a desk computer, a workbench, a personal digital assistant, a server, a blade server, a mainframe computer, and other appropriate computers. The electronic device may further be various forms of mobile communication apparatuses, such as a personal digital assistant, a cellular phone, a smartphone, a wearable device, and other similar computing apparatuses. The components illustrated herein, and connection relations and functions of the components are merely examples, and are not intended to limit implementations of the present disclosure described and/or required herein.

As shown in FIG. 4, the electronic device 40 includes a computing unit 401, which may perform various appropriate actions and processing based on a computer program stored in a read-only memory (ROM) 402 or a computer program loaded into a random access memory (RAM) 403 from a storage unit 408. Various programs and data necessary for the operation of the electronic device 40 may be further stored in the RAM 403. The computing unit 401, the ROM 402, and the RAM 403 are connected with each other through a bus 404. An input/output (I/O) interface 405 is also connected to the bus 404.

A plurality of components in the electronic device 40 are connected to the I/O interface 405, including: an input unit 406, for example, a keyboard or a mouse; an output unit 407, for example, various types of displays and speakers; the storage unit 408, for example, a magnetic disk or an optical disc; and a communication unit 409, for example, a network card, a modem, or a wireless communication transceiver. The communication unit 409 allows the electronic device 40 to exchange information/data with other devices through a computer network such as the Internet and/or various telecommunication networks.

The computing unit 401 may be various general-purpose and/or dedicated processing components having processing and computing capabilities. Some examples of the computing unit 401 include, but are not limited to, a central processing unit (CPU), a graphics processing unit (GPU), various dedicated artificial intelligence (AI) computing chips, various computing units running machine learning model algorithms, a digital signal processor (DSP), any appropriate processor, controller, microcontroller, and the like. The computing unit 401 performs methods and processing described above, for example, the scanned image acquisition method for a biological sample. For example, in some embodiments, the scanned image acquisition method for a biological sample may be implemented as a computer software program that is tangibly included in a computer-readable storage medium such as the storage unit 408. In some embodiments, part or entire of the computer program may be loaded into and/or installed on the electronic device 40 through the ROM 402 and/or the communication unit 409. When the computer program is loaded to the RAM 403 and is executed by the computing unit 401, one or more steps of the scanned image acquisition method for a biological sample described above may be performed. Alternatively, in another embodiment, the computing unit 401 may be configured to perform the scanned image acquisition method for a biological sample in any other appropriate manner (for example, through firmware).

Various implementations of the system and technology described above may be implemented in a digital electronic circuit system, an integrated circuit system, a field programmable gate array (FPGA), an application-specific integrated circuit (ASIC), an application-specific standard product (ASSP), a system-on-chip system (SOC), a complex programmable logic device (CPLD), computer hardware, firmware, software, and/or a combination thereof. These various implementations may include implementation in one or more computer programs. The one or more computer programs may be executed and/or interpreted on a programmable system including at least one programmable processor. The programmable processor may be a special-purpose or general-purpose programmable processor, may receive data and instructions from a storage system, at least one input apparatus, and at least one output apparatus, and transmit the data and instructions to the storage system, the at least one input apparatus, and the at least one output apparatus.

Program codes for implementing the method of the present disclosure may be written in one programming language or any combination of more programming languages. The program codes may be provided to a processor or controller of a general-purpose computer, a special-purpose computer, or another programmable data processing apparatus, so that the program codes, when executed by the processor or controller, enable functions/operations specified in the flowcharts and/or block diagrams to be implemented. The program codes may be completely executed on a machine, partially executed on a machine, partially executed on a machine as an independent software package and partially executed on a remote machine, or completely executed on a remote machine or a server.

In the context of the present disclosure, the computer-readable storage medium may be a tangible medium that may include or store a program used by or used in combination with an instruction execution system, apparatus, or device. The computer-readable storage medium may include, but is not limited to, an electric, magnetic, optical, electromagnetic, infrared, or semi-conductive system, apparatus, or device, or any appropriate combination thereof. More specific examples of the computer-readable storage medium may include an electrically connected based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

To provide interaction with a user, the system and technology described herein may be implemented on a computer. The computer has: a display apparatus for displaying information to the user (for example, a cathode ray tube (CRT) or liquid crystal display (LCD) monitor); and a keyboard and a pointing apparatus (for example, a mouse or a trackball). The user may provide an input to the computer by using the keyboard and the pointing apparatus. Another type of apparatus may be further used for providing interaction with the user. For example, feedback provided to the user may be any form of sensing feedback (for example, visual feedback, auditory feedback, or tactile feedback). In addition, the input from the user may be received in any form (including an optical input, a voice input, or a tactile input).

The system and technology described herein may be implemented in a computing system including a back-end component (for example, as a data server), or a computing system including a middleware component (for example, an application server), or a computing system including a front-end component (for example, a user computer having a graphical user interface or a network browser, where the user may interact with implementations of the system and technology described herein through the graphical user interface or the network browser), or a computing system including any combination of such back-end components, middleware components, or front-end components. The components of the system may be connected to each other by digital data communication (for example, a communication network) in any form or medium. Examples of the communication network include a local area network (LAN), a wide area network (WAN), and the Internet.

The computer system may include a client and a server. The client and the server are generally far away from each other and usually interact with each other through a communication network. The relationship between the client and the server is generated by using computer programs that are run on corresponding computers and that have a client-server relationship with each other. The server may be a cloud server, a server in a distributed system, or a server combined with a blockchain.

Those skilled in the art should understand that various forms of procedures shown above may be used to reorder, add, or delete steps. For example, the steps described in the present disclosure may be performed concurrently, or may be performed sequentially, or may be performed in different orders, as long as the steps can achieve the expected result of the technical solutions disclosed in the present disclosure, which is not limited in the present disclosure.

The foregoing descriptions illustrate merely specific implementations of the present disclosure. However, the protection scope of the present disclosure is not limited thereto. Any variation or replacement readily figured out by those skilled in the art within the technical scope disclosed in the present disclosure shall fall within the protection scope of the present disclosure.

1. A scanned image acquisition method for a biological sample, comprising the following steps:
acquiring a sectional sample of a to-be-scanned biological sample;
controlling a scanning transmission electron microscope to perform trans-scanning on the sectional sample based on a plurality of sets of focusing parameters, and collecting, during the trans-scanning and using a composite detector, a current signal set of the sectional sample at a focusing surface generated under each set of focusing parameters;
performing image processing on the current signal set at each focusing surface to obtain a plurality of signal images at each focusing surface; and
performing image filtering on the plurality of signal images at each focusing surface using an image filtering algorithm to obtain a plurality of layer scanned images, wherein a total quantity of the layer scanned images is different from a total quantity of the signal images.

2. The scanned image acquisition method according to claim 1, wherein the current signal set comprises a plurality of types of current signals, and the plurality of types of current signals comprise at least two of the following: secondary electron, backscattered electrons, Auger electron, energy dispersive X-ray spectroscopy, bright field, and dark field.

3. The scanned image acquisition method according to claim 1, wherein the composite detector comprises a secondary electron detector, a backscattered electron detector, a bright field detector, and a dark field detector.

4. The scanned image acquisition method according to claim 3, wherein the secondary electron detector is disposed right above the sectional sample, the backscattered electron detector is disposed on a side surface above the sectional sample, the bright field detector is disposed right below the sectional sample, and the dark field detector is disposed on a side surface below the sectional sample.

5. The scanned image acquisition method according to claim 1, wherein the image processing comprises multistage multiplication amplification, signal transformation, sampling, digital signal processing, and AI image extraction.

6. The scanned image acquisition method according to claim 1, wherein the plurality of sets of focusing parameters are acquired by the following sub-steps:
determining a scale factor of the sectional sample according to an original field of view size and a set limit size of the scanning transmission electron microscope, and adjusting a first gain and a second gain of the scanning transmission electron microscope according to the scale factor;
acquiring a quantity of required sets of focusing parameters, and determining a plurality of layers of the sectional sample according to the quantity of required sets; and
acquiring, for each layer, the focusing parameters of the layer using a parameter optimization algorithm to obtain the plurality of sets of focusing parameters, and restoring the first gain and the second gain to initial values.

7. The scanned image acquisition method according to claim 1, wherein the performing trans-scanning on the sectional sample comprises the following sub-steps:
focusing, by a converging lens of the scanning transmission electron microscope, a high-voltage focused incident electron beam into an electron beam probe, and performing point-by-point trans-scanning on the sectional sample based on the electron beam probe; and
deflecting, by a deflector of the scanning transmission electron microscope, the electron beam probe such that the electron beam probe performs line-by-line trans-scanning on the sectional sample;
wherein the point-by-point trans-scanning and the line-by-line trans-scanning are performed in a continuous wide-angle raster scanning manner.

8. The scanned image acquisition method according to claim 1, wherein the performing image filtering on the plurality of signal images at each focusing surface using an image filtering algorithm to obtain a plurality of layer scanned images specifically comprises the following sub-steps:
performing adaptive filtering denoising and spatial registration on all the signal images of each focusing surface to obtain aligned images corresponding to all the signal images;
calculating a quality score of each aligned image based on a definition, a noise level, and a structural similarity of the aligned image, and selecting effective images according to the quality scores of the aligned images;
initializing a point spread function according to a preset kernel function by taking the effective images as an input, and reconstructing images through a noise confidence-guided iterative deconvolution algorithm;
selecting a plurality of to-be-processed layer scanned images according to gradient features and noise confidences of the reconstructed images; and
performing luminance equalization and contrast enhancement on the plurality of to-be-processed layer scanned images to obtain the plurality of layer scanned images.

9. The scanned image acquisition method according to claim 8, wherein the noise confidence is obtained by the following method:
performing wavelet decomposition on the image to obtain high-frequency subbands to calculate global noise variance; calculating local variance through a sliding window; and obtaining the noise confidence of each pixel by exponential function mapping based on a difference between the local variance and the global variance.

10. The scanned image acquisition method according to claim 8, wherein, during the image reconstruction, point spread function parameters are adjusted according to a structural similarity gradient, and an update intensity is controlled through a noise weight matrix.

11. The scanned image acquisition method according to claim 1, wherein a section thickness of the sectional sample is 30 to 100 nm.

12. The scanned image acquisition method according to claim 1, wherein the quantity of the plurality of sets of focusing parameters is determined according to an axial resolution requirement of the scanned images, and the axial resolution requirement is a nanometer-scale resolution.

13. The scanned image acquisition method according to claim 1, wherein a sample processing device comprises a sectioning apparatus, a plasma processing apparatus, and a film coating apparatus, and the sectional sample is acquired from the sample processing device by the following sub-steps:
consecutively cutting the to-be-scanned biological sample using the sectioning apparatus to obtain a plurality of to-be-processed sample sections;
performing plasma thinning significance processing and surface conducting film plating on the plurality of sample sections using the plasma processing apparatus and the film coating apparatus to obtain a plurality of sample sections; and
determining the sectional sample from the plurality of sample sections.

14. A scanned image acquisition apparatus for a biological sample, comprising:
an acquisition module, configured to acquire a sectional sample of a to-be-scanned biological sample;
a collection module, configured to control a scanning transmission electron microscope to perform trans-scanning on the sectional sample based on a plurality of sets of focusing parameters, and collect, during the trans-scanning and using a composite detector, a current signal set of the sectional sample at a focusing surface generated under each set of focusing parameters;
an image processing module, configured to perform image processing on the current signal set at each focusing surface to obtain a plurality of signal images at each focusing surface; and
an image filtering module, configured to perform image filtering on the plurality of signal images at each focusing surface using an image filtering algorithm to obtain a plurality of layer scanned images, wherein a total quantity of the layer scanned images is different from a total quantity of the signal images.

15. An electronic device, comprising:
at least one processor; and
a memory communicatively connected to the at least one processor;
wherein the memory stores instructions executable by the processor, and the instructions are executed by the processor to cause the processor to implement the scanned image acquisition method according to claim 1.
